(19) United States
(12) Patent Application Publication
(10) Pub. No.: US 2010/0024886 A1
(43) Pub. Date: Feb. 4, 2010

(54) Sizing Solution Delivery Systems for A Sizing Press and Methods for Reducing Sizing Solution Volumes During Operation Therefof

(75) Inventor: William Daniel Seth, Waterford, PA (US)

Correspondence Address: CANTOR COLBURN, LLP, 20 Church Street, 22nd Floor, Hartford, CT, 06103, US

(73) Assignee: KEMIRA CHEMICALS, INC., Kennesaw, GA (US)

(21) Appl. No.: 12/511,255

(22) Filed: Jul. 29, 2009

Related U.S. Application Data
(60) Provisional application No. 61/084,893, filed on Jul. 30, 2008.

(51) Int. Cl. G05D 7/00; G05D 9/00; B08B 3/00

(52) U.S. Cl. 137/1; 137/391; 137/393; 137/15.05

(57) ABSTRACT

Sizing solution delivery systems for a sizing press and methods for reducing sizing solution volumes generally include a service tank containing an untreated sizing solution (e.g., starch), a standpipe having a volume capacity of less than the service tank, and an auxiliary chemical tank downstream from the service tank and the standpipe. The standpipe is configured to collect overflow fluid from the size press during use. In this configuration, the volumes of overflow solution provided in the loop are shortened, which reduces sizing solution volumes needed during purging for paper grade changes. In addition, time and equilibrium cycles are concomitantly reduced. Also disclosed are methods for reducing the sizing solution volumes and/or increasing sizing efficiency with the sizing solution delivery systems.

### CROSS REFERENCE TO RELATED APPLICATIONS

This application claims the benefits of the legally related U.S. Provisional Patent Application Ser. No. 61/084,893 filed Jul. 30, 2008, which is fully incorporated herein by reference.

### BACKGROUND

The present disclosure generally relates to sizing solution delivery systems for sizing presses and methods for reducing sizing solution volumes during use.

In most paper machines, a partially dried paper web is transported to a surface treatment device, commonly referred to as the size press or film press. There, between two rolls, the paper web is surface treated. The applicator is normally a simple arrangement of nozzles across the width of the unit. These units are usually used to apply thin mixes for sizing the sheet, wherein the term “sizing” generally refers to imparting a degree of water resistance. The most common substance used during surface treatment is a starch-based surface sizing solution, wherein the starch is either cooked or in a modified form, e.g., oxidized or enzyme converted. Starch improves the strength, appearance, finish, and printability of the paper as well as reduces paper dust. On occasion, wax emulsions or special resins are added to this solution. Other auxiliary chemicals such as dyes, optical brighteners, and chemicals may also be added to provide specific strength and particular optical characteristics.

Size presses come in various forms, including vertical, horizontal, inclined or gated and are used to apply the sizing solution to the top and bottom surfaces. By way of example, in the horizontal press, a bottom roll rotates in a pan filled with the sizing solution to coat the bottom surface and the same or different solution can be applied to the top surface using a showerhead or like means for delivering the size solution. In each case, however, the objective is to flood the entering nip with the sizing solution corresponding to the particular surface (top or bottom). When this occurs, the paper passing through the nips absorb some of the solution and the balance, i.e., the overflow solution, is removed from the nip. The overflow solution is collected below the nip. Typically, the overflow solution is fed back to the existing service tanks, where it can then be recirculated back to the nip.

In the case of auxiliary chemical treated sizing solution, such as dyes, optical brighteners, defoamers, fillers and the like, the auxiliary chemicals are typically added directly to the service tank or are metered into a conduit downstream from the service tank, which is in fluid communication with the size press such that the desired amount of auxiliary chemicals is supplied to the paper web. In these applications, the treated sizing solution is often recirculated back to the run tank, which can overflow to the sewer when using dye on one side. Once the desired amount of a particular grade is made, the conduits are purged until equilibrium is established for the chemicals used to produce the next paper grade.

Prior art FIG. 1 illustrates a typical sizing solution delivery system 10 including a size press 12. One or more service tanks (two of which are shown) 14, 14′ are provided for feeding a sizing solution 15 and/or a treated sizing solution 17 to the sizing press 12 via a pump 18. For example, in the case of two service tanks, one of the service tanks contains untreated sizing solution 15 and the other service tank may contain treated sizing solution 17. The service tanks typically provide a volume capacity of about 300 to about 500 gallons or greater. The overflow sizing solution, i.e., the return sizing solution, is fed through a screen 20 and returned to a selected one of the service tanks. The auxiliary chemicals 22 such as the dyes and optical brighteners are added downstream from the service tanks or can be contained within an additional service tank. The system further includes one or more valves 24 to fluidly regulate flow between the different system components during use. After a particular grade of paper has been produced, the conduits need to be purged so as to produce the next grade of paper from sizing solutions having the desired specifications. Large amounts of fresh untreated sizing solution from the service tank 14 are needed to flush the conduits, which is then fed to the waste reservoir. Thus, significant amounts of untreated sizing solution that are needed to flush the conduits becomes mixed with and contaminated by the residual solution (which contains auxiliary chemicals) in the conduits. Apart from the cost of the untreated sizing solution itself, additional costs are incurred for removal of the waste since the now contaminated flushed sizing solution cannot reused. Likewise, if the grade calls for a particular auxiliary chemical, a significant amount of time and sizing solution are needed so as to establish a proper equilibrium within the system that meets the desired specifications for the paper grade.

Although conventional papermaking processes allow for the production of a variety of graded papers, there is clearly a need to improve these processes especially as it relates to the application of sizing solutions containing auxiliary chemicals. A great deal of waste and inefficiency has been observed with current papermaking processes.

### BRIEF SUMMARY

Disclosed herein are sizing solution delivery systems for sizing presses and methods for reducing sizing solution volumes during use. In one embodiment, a sizing solution delivery system for a size press comprises a sizing solution service tank containing an untreated sizing solution having an outlet in fluid communication with a first conduit, wherein the first conduit is in fluid communication with the size press; a standpipe having a volume capacity of less than the sizing solution service tank, wherein the standpipe has an outlet conduit in fluid communication with the first conduit and an inlet in fluid communication with a second conduit, wherein the second conduit is configured to receive and contain an overflow fluid from the size press during use thereof, a level indicating control valve disposed in the first conduit and intermediate the service tank and the standpipe, wherein the liquid indicating control valve regulates a fluid level of the overflow solution in the standpipe to be less than a fluid level of the untreated sizing solution in the service tank; and an auxiliary chemical tank downstream from the service tank and the standpipe, the auxiliary chemical tank in fluid communication with the first conduit and operative to introduce an auxiliary chemical into the first conduit.

In another embodiment, a sizing solution delivery system for a size press comprises a service tank containing an untreated sizing solution having an outlet in fluid communication with a first conduit and a third conduit, wherein the first and third conduits are in fluid communication with the size press, and wherein the third conduit is configured to provide a bypass of the untreated sizing solution from the service tank to the size press; a standpipe having a volume capacity of less than the starch service tank disposed within the service tank, wherein the standpipe has an outlet conduit in fluid communication with the first conduit and an inlet in fluid communication with a second conduit, wherein the second conduit contains overflow fluid from the size press during use thereof; a level indicating control valve disposed in the outlet conduit of the standpipe, wherein the level indicating control valve maintains a fluid level of the overflow solution in the standpipe to be less than a fluid level of the untreated starch sizing solution in the service tank, and an auxiliary chemical tank downstream from the starch service tank and the standpipe, the auxiliary chemical tank in fluid communication with the first conduit and operative to introduce an auxiliary chemical into the first conduit.

A method for reducing sizing solution volumes and/or increasing sizing efficiency comprises purging the sizing solution delivery system once a desired paper grade has been made, wherein the sizing solution delivery system comprises a looped system comprising a standpipe configured to receive an overflow fluid comprising auxiliary chemicals from a size press, a service tank comprising an untreated sizing solution upstream from the standpipe, and a transfer pump downstream from the service tank and standpipe, wherein purging comprises closing a valve to the standpipe to permit the untreated sizing solution to flow to a waste reservoir while simultaneously or subsequently closing flow to the transfer pump downstream from the standpipe; and opening flow to the transfer pump while simultaneously or subsequently closing flow to the waste reservoir.

In another embodiment, a method for operating a sizing solution delivery system method comprises applying an excess of treated sizing solution to at least one side of a partially dried paper web in a size press, wherein the treated sizing solution contains at least one auxiliary chemical; collecting the excess sizing solution in the sizing solution delivery system, the sizing solution delivery system comprising a sizing solution service tank containing an untreated sizing solution having an outlet in fluid communication with a first conduit in fluid communication with the size press; a standpipe having an outlet conduit in fluid communication with the first conduit and an inlet in fluid communication with a second conduit, wherein the second conduit receives the excess sizing solution from the size press during use thereof; and maintaining a fluid level of the excess sizing solution in the standpipe to be less than a fluid level of the untreated sizing solution in the service tank.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

Prior art FIG. 1 illustrates a typical sizing solution delivery system for applying a sizing solution to a partially dried paper web;

FIG. 2 illustrates a sizing solution delivery system in accordance with one embodiment of the present disclosure; and

FIG. 3 illustrates a sizing solution delivery system in accordance with another embodiment of the present disclosure.

### DETAILED DESCRIPTION

The present disclosure is generally directed to a sizing solution delivery system for sizing presses and methods for reducing sizing solution volumes during use. The sizing solution delivery system disclosed herein provides a continuous looped system that addresses the various issues discussed above that can occur upon, for example, the application of auxiliary chemicals such as dyes and optical brighteners to form a desired paper grade. The system generally includes a separate smaller volume service tank having about a 10 to about 15 gallon capacity, referred to herein as a standpipe, for the auxiliary chemical containing solution, which is in addition to a fresh sizing solution service tank (about 300 to 500 gallon capacity). The use of the smaller volume tank provides numerous advantages as will be apparent below. For example, the smaller volume tank eliminates the need to continuously dump the chemically treated overflow solution from the size press. Instead, the overflow solution can be fed directly to the smaller volume service tank and recycled until the amount of desired paper grade has been reached. In addition, the smaller volume service tank for the auxiliary chemical containing solution reduces the times it takes to purge the system when a paper grade changes. Because of this, the sizing solution delivery system and process reduces turnover time when preparing different grades of paper. Still further, the use of the standpipe receives the return sizing solution without mechanical mixing, thereby minimizing formation of a form. In addition, entrained air in the return sizing solution can advantageously be removed.

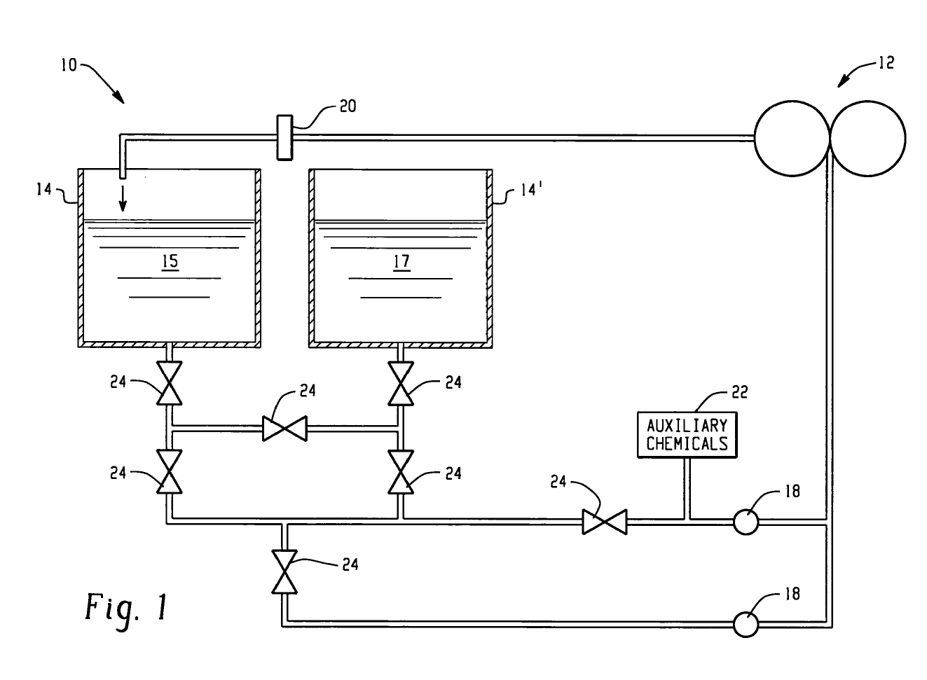

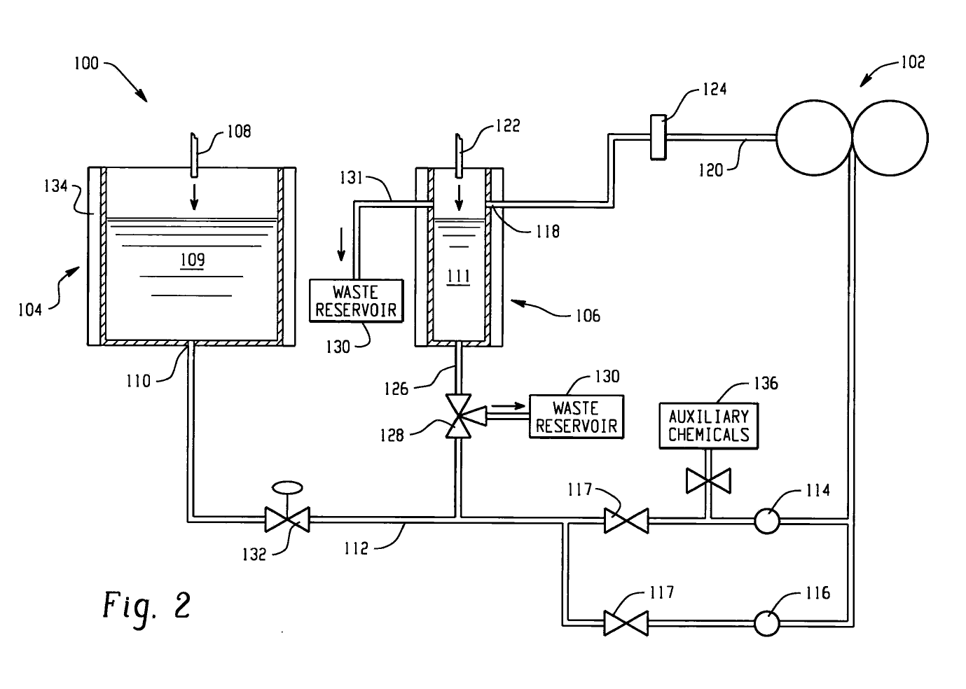

FIG. 2 illustrates a sizing solution delivery system in accordance with the present disclosure, generally designated by reference numeral 100. The system 100 is configured to provide a sizing solution to a sizing press 102 while reducing sizing solution volumes and equilibrium times during paper grade changes. The sizing press 102 is not intended to be limited and can be any one of a vertical, horizontal, inclined, or gated size press. The sizing solution delivery system 100 generally includes a sizing solution service tank 104 and a standpipe 106. The sizing service tank contains an untreated sizing solution whereas the standpipe contains a treated sizing solution. As used herein the term “untreated” is intended to indicate that the sizing solution is substantially free from auxiliary chemical agents whereas the term “treated” is intended to indicate that auxiliary chemicals such as colorants, e.g., dyes, optical brighteners, fillers, and/or the like, have been added to the sizing solution. In this manner, the untreated sizing solution may comprise a starch based sizing solution, a sizing solution that includes one or more types of resins and waxes, polymers, and the like. It should be noted that the composition of the sizing solution does not require starch and may be composed of resins, waxes, polymers, and/or the like. A sizing solution may also be a coating colour, i.e., a coating formulation that contains pigments, binders, and/or the like and is formulated to affect porosity and/or opacity of the paper.

The service tank 104 includes an inlet 108 for receiving a fresh sizing solution 109 (i.e., untreated sizing solution) and an outlet 110 for discharging the fresh sizing solution 109 into a first conduit 112, which is in fluid communication with the size press 102 via pump 114 or via at least one or more secondary pump 116 depending on the number of loops within the system One or more valves 117 may be disposed in the first conduit to control flow to the appropriate pump for delivering the sizing solution to the size press 102 as well as for purging operations such as when there is a grade change. For example, the paper grade being manufactured may desire one surface to be coated with a starch solution containing an optical brightener whereas the other surface is coated with the untreated starch solution.

The standpipe 106 includes an inlet opening 122 for introducing a treated sizing solution 111 into the standpipe. Although the standpipe 106 is shown proximate to the service tank 104, the particular location of the standpipe 106 relative to the service tank 104 is not intended to be limited. The standpipe 106 can be disposed within the service tank itself or may be mounted directly to an exterior wall of the service tank. By disposing the standpipe within the service tank or by coupling the standpipe directly to an exterior wall of the service tank, the ambient heat from the service tank can be employed to heat the standpipe, thereby eliminating a need to heat the overflow return conduit.

The standpipe 106 may also include an inlet 118 in a sidewall for receiving the overflow solution 111 from the sizing press via a second conduit 120. Alternatively, the overflow solution 111 may be fed through inlet opening 122. An optional mesh screen 124 is in fluid communication with the overflow solution within the second conduit. The mesh screen 124 is intermediate the size press 102 and the standpipe 106 and serves to filter the overflow solution, which may contain particulate matter such as fibrous material, paper dust, and the like. As noted above, the standpipe 106 is configured to have a significantly smaller volume than the service tank 104, and is generally dimensioned based upon the intended flow rate of the solution contained therein to the size press 102. For example, the lower the intended flow rate, the smaller the volume dimension that is generally required. In one embodiment, the standpipe is less than 50 percent of the service tank volume, in other embodiments, less than 40 percent of the service tank volume, and in still other embodiments, less than 30 percent of the service tank volume. Still further, in other embodiments, the standpipe is less than 20 percent of the service tank volume; in still other embodiments, less than 10 percent of the service tank volume and in yet other embodiments, is less than 5 percent of the service tank volume. The volume of the standpipe relative to the service tank volume generally depends on the intended application, the space available, and the like. By way of example, for a dye solution, the sizing solution service tank 104 can have a capacity of about 300 to 500 gallons of an untreated sizing solution whereas the standpipe 106, which would contain the dye containing solution, would have a capacity of about 10 to 15 gallons.

The standpipe 106 includes an outlet conduit 126, which is in fluid communication with conduit 112 and is shown intermediate the starch service tank 104 and the size press 102. The standpipe 106 further includes an overflow conduit 131 in fluid communication with a waste reservoir 130, e.g., a sewer line, wherein the overflow conduit 131 is disposed at an upper location of the standpipe so as to prevent the standpipe from overflowing. The standpipe outlet 126 includes a valve 128 disposed between the outlet and the conduit 112. In one embodiment, the valve 128 is a three way valve as shown so as to selectively control fluid flow from the standpipe 106 into a waste reservoir 130, and/or into the conduit 112. Alternatively, the standpipe outlet 126 can include two or more valves, e.g., solenoid valves, to permit selective fluid flow to either the waste reservoir 130 or the conduit 112. In this manner, the conduit 112 can be periodically purged between the valve 128 and the pump 114 or 116 as may be needed for grade changes. For example, the valve 128 can be programmed to open to the waste reservoir 130 first while closed to the pump 114 or 116. When switching back, the valve 128 would be open to the pump 114 or 116 and be closed to the waste reservoir 130.

A level indicating control valve (LICV) 132 is disposed intermediate the service tank 104 and the standpipe 106. The LICV 132 maintains a predetemined level of sizing solution within the standpipe 106. In one embodiment, the level within the standpipe is maintained less than that present in the service tank so as to prevent backflow into the service tank, which would contaminate the sizing solution contained within the service tank 104.

Optionally, a water jacket 134 can be used to heat the service tank and/or the standpipe. Alternatively, steam can be used to heat the service tank and/or standpipe. By way of example, a paper mill could use steam and/or the reclaimed dryer condensate water (not shown) to heat the service tanks and/or standpipe.

The auxiliary chemicals 136 are metered into conduit 112 at a location downstream from the service tank 104 and standpipe 106. The auxiliary chemicals mix with the untreated sizing solution from the service tank 104 to form a treated sizing solution and are delivered to the size press. Overflow treated sizing solution from the size press 102 is configured to return via the second conduit 120 to the standpipe 106, as opposed to the service tank 104 or to the waste reservoir 130, thereby allowing the service tank 104 to remain free of auxiliary chemicals. As such, the use of the standpipe 106 eliminates the need to have a continuous runoff of the treated sizing solution into the waste reservoir. Moreover, the valve 128 disposed in the standpipe outlet conduit 126 can be used to easily purge the conduit 112 when it is necessary to change the amounts and composition of the auxiliary chemicals, e.g., color or optical brightener usage, such as may be the case during a grade change. Still further, as the level in the standpipe drops, the valve 128 opens to allow replenishing sizing solution to enter the standpipe 106 from the service tank 104. In the event the level increases to one greater than that in the service tank, the valve would be configured to close so as to prevent backwash from the standpipe 106 into the service tank 104. Monitors such as spectrophotometers and other like analytical tools (not shown) can be used to regulate the desired amounts of auxiliary chemicals needed to provide the desired paper grade.

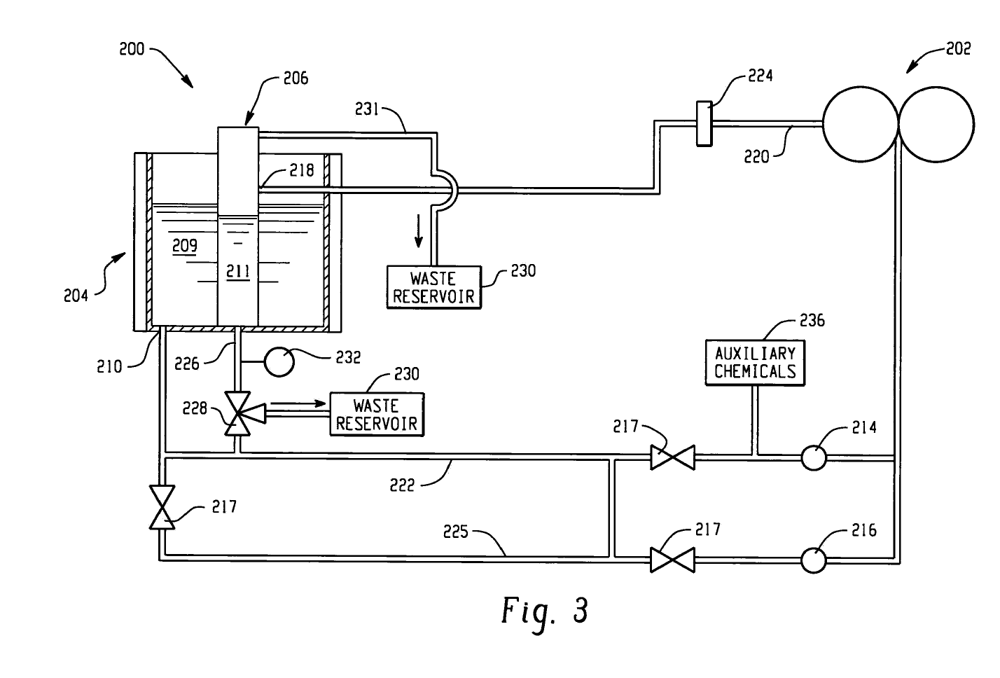

FIG. 3 illustrates a sizing solution delivery system 200 in accordance with another embodiment. In this embodiment, the standpipe 206 is disposed within the service tank 204 so as to eliminate the need for an external heat source such as steam heat or the like for the second conduit 220 or for the standpipe itself. As shown, the sizing solution delivery system 200 generally includes a service tank 204 for housing an untreated sizing solution 209, a standpipe for housing the treated sizing solution 211 disposed within the service tank 204, and a size press 202. The service tank 204 and the standpipe 206 include outlets 210, 226, respectively, that are fluidly connected to the first conduit 222, which is in fluid communication with the size press 202. A second conduit 220 provides fluid communication for flowing the overflow fluid from 211 from the size press 202 to the standpipe 206 via inlet 218. A third conduit 225 is in fluid communication with the outlet conduit 210 of the service tank as shown. Various valves 217 may be disposed in the conduits 222, and 225 so as to control flow during use and during purging operations. Pumps 214, 216 are provided to circulate the sizing solution. Downstream from the service tank and the standpipe is an auxiliary chemical tank for introducing an auxiliary chemical into the circulation. The standpipe 206 includes an overflow conduit 231 in fluid communication with a waste reservoir 130, e.g., sewer, in the event the capacity of the standpipe is exceeded. As in the previous embodiment, valve 228 can be a three way valve for controlling flow of the treated sizing solution into the conduit or to the waste reservoir or to allow replenishment of the standpipe with untreated sizing solution from the service tank 204. Alternatively, valve 28 can be two solenoid valves for controlling flow. Outlet conduit 226 further includes a level indicating control valve 232 in operative communication with the service tank and the standpipe for controlling the fluid level within the service tank and the standpipe. In this manner, the standpipe can have a fluid level less than that in the service tank so as to prevent backflow of the treated sizing solution into the service tank.

The various systems described herein may be configured manually or may include an automatic control system (not shown) for operating the systems.

The starch, which is commonly used in the sizing solution, may be of any type, including but not limited to, oxidized, ethylated, cationic and pearl, and is preferably used in aqueous solution. Typically, starch sizing solutions with solids up to 12% are used and the viscosity is generally less than 100 mPas (RV measurement at 50° C.) to prevent runnability problems.

Illustrative of useful starches are naturally occurring carbohydrates synthesized in corn, tapioca, potato and other plants by polymerization of dextrose units. All such starches and modified forms thereof such as starch acetates, starch esters, starch ethers, starch phosphates, starch xanthates, anionic starches, cationic starches and the like which can be derived by reacting the starch with a suitable chemical or enzymatic reagent can be used in the practice of this invention. Useful starches may be prepared by known techniques or obtained from commercial sources. For example, the suitable starches include PG-280 from Penford Products, SLS-280 from St. Lawrence Starch the cationic starch CatoSize 270 from National Starch and the hydroxypropyl No. 02382 from Poly Sciences, Inc.

The amount of starch or polymer, waxes, or the Ike in the size press composition can be varied widely and any amount can be used. For example, the amount of starch can be as high as about 100%, and as low as about 50% or higher based on the total weight of the composition. The amount of starch is preferably from about 60% to about 90%, more preferably from about 65% to about 85% and most preferably from about 70% to about 80%, based on the total weight of the composition.

The auxiliary chemical agents include, without limitation, dispersants, fluorescent dyes, surfactants, deforming agents, preservatives, pigments, binders, pH control agents, coating releasing agents, fillers, and the like.

Paper and paperboard substrates used in the practice of this invention can vary widely. Such paper and paperboard substrates and methods and apparatus for their manufacture are well known in the art. See for example “Handbook For Pulp & Paper Technologies”, 2^{nd} Edition, G. A. Smook, Angus Wilde Publications (1992) and references cited therein, which are hereby incorporated, in their entirety, herein by reference. For example, the paper or paperboard web can be made from pulp fibers derived from hardwood trees, softwood trees, or alternatively, a combination of hardwood and softwood trees is prepared for use in a papermaking furnish by any known suitable digestion, refining, and bleaching operations, as for example, known mechanical, thermomechanical, chemical and semi chemical, pulping and other well known pulping processes. In certain embodiments, at least a portion of the pulp fibers may be provided from non-woody herbaceous plants including, but not limited to, kenaf, hemp, jute, flax, sisal, or abaca although legal restrictions and other considerations may make the utilization of hemp and other fiber sources impractical or impossible. Either bleached or unbleached pulp fiber may be utilized in the process of this invention. Recycled pulp fibers are also suitable for use. In the preferred embodiment, the cellulosic fibers in the paper or related web include from about 0% to about 100% by weight dry basis softwood fibers and from about 100% to about 0% by weight dry basis hardwood fibers.

The density, basis weight and caliper of the paper or paperboard web of this invention may vary widely. For example, any conventional basis weights, densities and calipers may be employed depending on the paper-based product formed from the web.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A sizing solution delivery system for a size press, comprising:
a sizing solution service tank containing an untreated sizing solution having an outlet in fluid communication with a first conduit, wherein the first conduit is in fluid communication with the size press;
a standpipe having a volume capacity less than the sizing solution service tank, wherein the standpipe has an outlet conduit in fluid communication with the first conduit and an inlet in fluid communication with a second conduit, wherein the second conduit is configured to receive and contain an overflow fluid from the size press during use thereof,
a level indicating control valve disposed in the first conduit and intermediate the service tank and the standpipe, wherein the liquid indicating control valve regulates a fluid level of the overflow solution in the standpipe to be less than a fluid level of the untreated sizing solution in the service tank; and
an auxiliary chemical tank downstream from the service tank and the standpipe, the auxiliary chemical tank in fluid communication with the first conduit and operative to introduce an auxiliary chemical into the first conduit.

2. The sizing solution delivery system of claim 1, wherein the second conduit comprises a screen filter intermediate the size press and the standpipe.

3. The sizing solution delivery system of claim 1, wherein the standpipe is downstream from the sizing solution service tank.

4. The sizing solution delivery system of claim 1, wherein the standpipe is disposed within the sizing solution service tank.

5. The sizing solution delivery system of claim 1, wherein the standpipe is coupled to an exterior wall of the sizing solution service tank.

6. The sizing solution delivery system of claim 1, wherein the volume capacity of the standpipe is less than about 5 percent of the sizing solution service tank volume capacity.

7. The sizing solution delivery system of claim 1, wherein the standpipe outlet conduit comprises a three-way check valve.

8. The sizing solution delivery system of claim 1, wherein the level indicating control valve is configured to introduce untreated sizing solution from the sizing solution service tank to the standpipe when the level of overflow fluid within the standpipe is below a predetermined level.

9. The sizing solution delivery system of claim 1, wherein the level indicating control valve is configured to prevent backflow of the overflow fluid from the standpipe to the service tank when a predetermined level of overflow fluid within the standpipe is exceeded.

10. The sizing solution delivery system of claim 1, wherein the standpipe volume capacity is less than about 10 percent of a volume capacity for the sizing solution service tank.

11. A sizing solution delivery system for a size press, comprising:
a service tank containing an untreated sizing solution having an outlet in fluid communication with a first conduit and a third conduit, wherein the first and third conduits are in fluid communication with the size press, and wherein the third conduit is configured to provide a bypass of the untreated sizing solution from the service tank to the size press;
a standpipe having a volume capacity less than the starch service tank disposed within the service tank, wherein the standpipe has an outlet conduit in fluid communication with the first conduit and an inlet in fluid communication with a second conduit, wherein the second conduit contains overflow fluid from the size press during use thereof,
a level indicating control valve disposed in the outlet conduit of the standpipe, wherein the level indicating control valve maintains a fluid level of the overflow solution in the standpipe to be less than a fluid level of the untreated starch sizing solution in the service tank; and
an auxiliary chemical tank downstream from the starch service tank and the standpipe, the auxiliary chemical tank in fluid communication with the first conduit and operative to introduce an auxiliary chemical into the first conduit.

12. The sizing solution delivery system of claim 11, wherein the second conduit comprises a screen filter intermediate the size press and the standpipe.

13. The sizing solution delivery system of claim 11, wherein the volume capacity of the standpipe is less than about 5 percent of the sizing solution service tank volume capacity.

14. The sizing solution delivery system of claim 11, wherein the outlet conduit comprises a three way check valve downstream from the level indicating control valve.

15. The sizing solution delivery system of claim 11, wherein the level indicating control valve is configured to introduce untreated sizing solution from the service tank to the standpipe when the level of overflow fluid within the standpipe is below a predetermined level.

16. The sizing solution delivery system of claim 11, wherein the level indicating control valve is configured to prevent backflow of the overflow fluid from the standpipe to the service tank when a predetermined level of overflow fluid within the standpipe is exceeded.

17. The sizing solution delivery system of claim 11, wherein the standpipe volume capacity is less than about 10 percent of a volume capacity for the sizing solution service tank.

18. A method for reducing sizing solution volumes and/or increasing sizing efficiency in a sizing solution delivery system for a size press, the method comprising:
purging the sizing solution delivery system once a desired paper grade has been made, wherein the sizing solution delivery system comprises a looped system comprising a standpipe configured to receive an overflow fluid comprising auxiliary chemicals from a size press, a service tank comprising an untreated sizing solution upstream from the standpipe, and a transfer pump downstream from the service tank and standpipe, wherein purging comprises:
closing a valve to the standpipe to permit the untreated sizing solution to flow to a waste reservoir while simultaneously or subsequently closing flow to the transfer pump downstream from the standpipe; and
opening flow to the transfer pump while simultaneously or subsequently closing flow to the waste reservoir.

19. The method of claim 18, further comprising regulating a fluid level of the overflow fluid in the standpipe to be less than a fluid level of the untreated sizing solution in the service tank.

20. The method of claim 18, wherein the standpipe is disposed within the service tank.

21. The method of claim 18, wherein regulating the fluid level comprises introducing untreated sizing solution from the service tank to the standpipe when the fluid level within the standpipe is below a predetermined level.

22. The method of claim 18, wherein regulating the fluid level comprises preventing backflow of the overflow fluid from the standpipe to the service tank when a predetermined level of the overflow fluid within the standpipe is exceeded.

23. A method for operating a sizing solution delivery system, the method comprising:
applying an excess of treated sizing solution to at least one side of a partially dried paper web in a size press, wherein the treated sizing solution contains at least one auxiliary chemical;
collecting the excess sizing solution in the sizing solution delivery system, the sizing solution delivery system comprising a sizing solution service tank containing an untreated sizing solution having an outlet in fluid communication with a first conduit in fluid communication with the size press; a standpipe having an outlet conduit in fluid communication with the first conduit and an inlet in fluid communication with a second conduit, wherein the second conduit receives the excess sizing solution from the size press during use thereof; and
maintaining a fluid level of the excess sizing solution in the standpipe to be less than a fluid level of the untreated sizing solution in the service tank.
